(19) United States
(12) Patent Application Publication
(10) Pub. No.: US 2023/0406421 A1
(43) Pub. Date: Dec. 21, 2023

(54) STORAGE SYSTEMS FOR A VEHICLE

(71) Applicant: RIVIAN IP HOLDINGS, LLC, Irvine, CA (US)

(72) Inventors: Philipp Wolf, Dana Point, CA (US); Jim Dowle, Laguna Beach, CA (US); Barry Lett, Surrey (GB); Mark Taylor, Laguna Beach, CA (US)

(21) Appl. No.: 17/845,649

(22) Filed: Jun. 21, 2022

(51) Int. Cl. B62D 43/04

(52) U.S. Cl. CPC B62D 43/04

(57) ABSTRACT

A vehicle includes a system for storing items that achieves a stowed configuration and an accessible configuration. The storage system includes a tray affixed to a frame of the vehicle by a joint, and optionally an element arranged on a top surface of the tray for holding items. In the stowed configuration, the tray and optional element are tucked under the vehicle. In the accessible configuration, the tray is positioned outward of a bumper of the vehicle. The tray may optionally rotate, translate, swing, or undergo a combination thereof, to achieve the accessible configuration from the stowed configuration and return to the stowed configuration from the accessible configuration. For example, when stowed the tray is arranged between a drive unit and the bumper, beneath the vehicle, and then moves into a more accessible position at least partially outward of the bumper such that a user can retrieve or store items.

### INTRODUCTION

The present disclosure is directed to storage systems for a vehicle and, more particularly, to systems having a tray that achieves a trajectory to provide access to storage from an end of the vehicle.

### SUMMARY

The present disclosure is directed to a storage system for a vehicle. In some embodiments, the storage system is arranged beneath a cargo bed or occupant compartment of the vehicle, (longitudinally) outward of a drive unit of the vehicle. The storage system includes a tray assembly that is configured to achieve at least two positions: a stowed position and a released position. The tray may translate horizontally, swing down, or rotate below horizontal. In some embodiments, the storage system includes a tray that extends from the tray outwards from the vehicle to provide greater access by the user. To illustrate, in the stowed position, the tray is tucked inward of the bumper and under the cargo bed or occupant compartment, and in the released position, the tray or an element, such as an insert or sheet, may extend at least partially beyond the bumper. In some embodiments, displacement of the tray is achieved under manual control, using a winch system, for example. In some embodiments, the displacement of the tray is achieved under automatic control, using one or more actuators.

The present disclosure is directed to a system for storage in a vehicle. In some embodiments, the system includes a tray and an element such as a sheet or an insert. The tray is arranged outward of the drive unit (e.g., at an end of the vehicle) and is affixed to a frame of the vehicle by a hinge joint. The element is arranged on a top surface of the tray and capable of sliding longitudinally along the tray and may be capable of storing equipment under a compartment of the vehicle. In a first configuration, the tray is oriented horizontal and the sheet is in a stowed position under a compartment of the vehicle, and in a second configuration, the tray is oriented at an angle below horizontal such that the element is capable of sliding under a bumper of the vehicle. In some embodiments, the compartment is a cargo bed, and the tray is arranged beneath the cargo bed. In some embodiments, the system includes a latch for securing and releasing the tray from the frame of the vehicle. In some embodiments, the element includes a sheet and a holddown, and is configured to store a spare tire of the vehicle.

In some embodiments, the system includes a winch that is accessible from the end of the vehicle. For example, the winch is affixed to the frame of the vehicle, a flexible element of the winch is affixed to the tray, and the tray rotates as the flexible element is advanced or retracted. The flexible element includes a winch cable, chain, or other suitable element that undergoes tension. In some embodiments, the system includes a winch accessible from the end of the vehicle. The winch is affixed to the frame of the vehicle, a flexible element of the winch is affixed to the element, and the element extends as the flexible element is advanced. The flexible element includes a winch cable or other suitable element capable of withstanding suitable tension. In some embodiments, the flexible element slidably interfaces to the tray, and the tray rotates as the flexible element is advanced or retracted.

In some embodiments, in a third configuration, the tray is oriented at the angle below horizontal, and the element is positioned outward away from the vehicle relative to a position of the element in the second configuration. In some such embodiments, in the third configuration, the sheet is positioned at least partially outward of the bumper, by extending the sheet, for example.

In some embodiments, the bumper is a rear bumper, and in the first position, the tray is arranged longitudinally forward of the rear bumper. For example, in some embodiments, the vehicle includes a rear drive unit for driving rear wheels of the vehicle, and the tray is arranged rearward of the rear drive unit. In some embodiments, the frame of the vehicle includes at least one frame element and a strut affixed to the at least one frame element. For example, in some such embodiments, the hinge joint affixes the tray to the strut.

In some embodiments, the present disclosure is directed to a system having a tray capable of storage and achieving two or more configurations. The tray is arranged outward (e.g., longitudinally outward) of a drive unit of the vehicle and is capable of storing equipment under a compartment of the vehicle. In a first configuration, the tray is stowed under the compartment and a bumper portion of the vehicle is in a first bumper position, and in a second configuration, the tray is arranged at least partially outward of the first bumper position. In some embodiments, in the second configuration, the bumper portion is in second bumper position outward of the first bumper position. In some embodiments, in the second configuration, the tray is lower than the first bumper position. In some embodiments, the system includes a four-bar linkage coupling the tray to a frame of the vehicle. For example, the four-bar linkage is configured to cause the tray to achieve the first configuration and the second configuration. In a further example, in the second configuration, the tray is also arranged at least partially below the first bumper position. In some embodiments, the system includes a slide interface between the tray and a frame of the vehicle, and the tray is configured to slide to achieve the first configuration and the second configuration. The bumper portion may include some of the bumper, or the entire bumper.

In some embodiments, the present disclosure is directed to a vehicle having a drive unit, a frame, a tray and optionally an element. The drive unit is arranged at a drive axis of the vehicle. The tray is arranged at an end of the vehicle and affixed to the frame of the vehicle by a hinge joint. The element, which may be a sheet, insert, cradle, or enclosure, is arranged on a top surface of the tray and capable of sliding longitudinally along the tray and capable of storing equipment under a compartment of the vehicle. In a first configuration, the tray is oriented horizontal and the element is in a stowed position, and in a second configuration, the tray is oriented at an angle below horizontal such that the element is capable of sliding outward under a bumper of the vehicle. In some embodiments, the vehicle includes a winch accessible from the end of the vehicle. The winch is affixed to the frame, a flexible element of the winch is coupled to the tray, and the tray rotates as the flexible element is advanced. In some embodiments, in the first configuration, the tray is arranged inward of the bumper, and in a third configuration, the tray is oriented at the angle below horizontal and the element is in an extended position, at least partially outward of the bumper.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a side view of an illustrative vehicle having a storage system, in accordance with some embodiments of the present disclosure;

FIG. 2 shows several illustrative embodiments of storage systems, in accordance with some embodiments of the present disclosure;

FIG. 3 shows side views of an illustrative system for storing items in a vehicle, corresponding to several configurations, in accordance with some embodiments of the present disclosure;

FIG. 4-6 show perspective views of an illustrative storage system in several configurations, in accordance with some embodiments of the present disclosure;

FIG. 7 show perspective views of several components of the illustrative storage system of FIGS. 4-6, in accordance with some embodiments of the present disclosure;

FIG. 8 shows side views of another illustrative system for storing items in a vehicle, corresponding to several configurations, in accordance with some embodiments of the present disclosure;

FIG. 9 shows side views of another illustrative system for storing items in a vehicle, corresponding to two configurations, in accordance with some embodiments of the present disclosure;

FIG. 10 is a system diagram of an illustrative vehicle having a storage system, in accordance with some embodiments of the present disclosure;

FIG. 11 is a block diagram of an illustrative storage system, in accordance with some embodiments of the present disclosure; and

FIG. 12 is a flowchart of an illustrative process for accessing and stowing a storage system of a vehicle, in accordance with some embodiments of the present disclosure.

### DETAILED DESCRIPTION OF THE DRAWINGS

Vehicles may include storage for equipment, gear, valuables, a spare tire, or other items. While some solutions either require access through a truck bed or involve complicated access through the bottom of the vehicle (e.g., underneath the vehicle), more accessibility would be helpful to the user. The present disclosure is directed to storage systems of a vehicle that provide improved accessibility without requiring access via a cargo bed or occupant compartment. In some embodiments, the storage system includes a winch and/or crank mechanism for actuating a tray of the storage system between a stowed position and an accessible position. The actuation may be manual or powered (e.g., electric or hydraulic powered). In some embodiments, the storage system may include gas struts, dampers, springs, detents, bump stops, cable stops, or any other suitable components to affect displacement of the tray. The storage system is arranged under the vehicle when stowed, thus utilizing “dead space,” and is moved to a position at least partially outward of the vehicle bumper to provide accessibility, for example. Outward may be considered relative from the center of the vehicle, such that a position forward of a front bumper, or rearward of a rear bumper, corresponds to outward. For example, by arranging the storage system under the vehicle, spare tire access may be provided without requiring access through a cargo bed (e.g., the bed need not be cleared of items to access storage). In some embodiments, for example, the storage system allows the user to avoid disassembly of trim parts to access the tire, and/or to avoid dragging a spare tire out from underneath the vehicle.

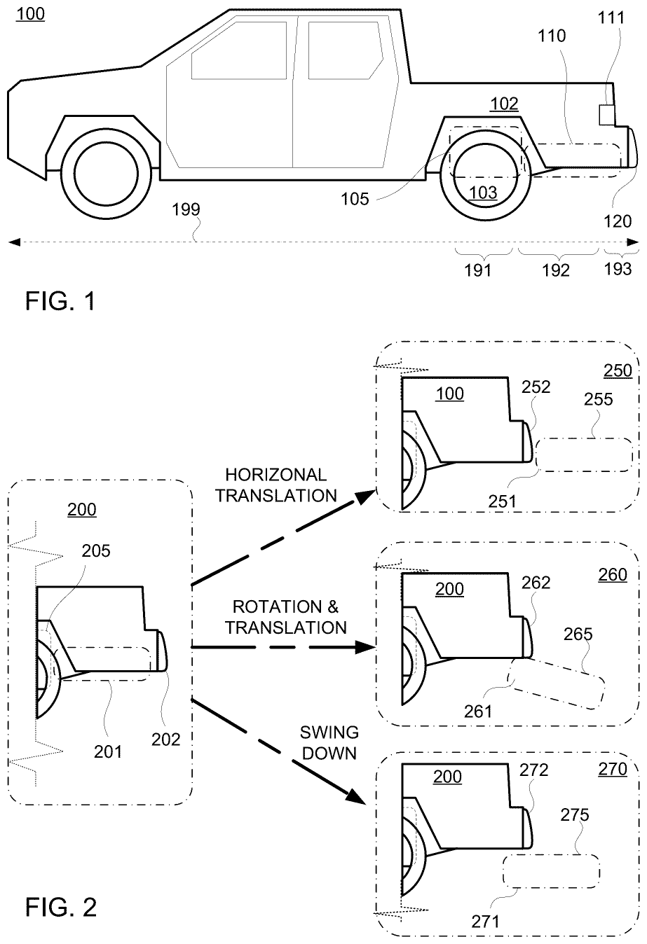

FIG. 1 shows a side view of illustrative vehicle 100 having storage system 110, in accordance with some embodiments of the present disclosure. Vehicle 100 is illustrated as a truck in FIG. 1, but the systems of the present disclosure may be applied to any suitable vehicle such as, for example, an electric vehicle, a sedan, a coupe, a sport utility vehicle (SUV), a crossover, a station wagon, a van, a truck having more than two axles, or any other suitable vehicle. As illustrated, vehicle 100 includes compartment 102, drive unit 105, bumper 120, access 111, and storage system 110 (e.g., illustrated as a rear storage system). Although compartment 102 is illustrated as a cargo bed, compartment 102 may include an occupant compartment (e.g., such as a van or SUV), a truck bed, or any other suitable compartment, in accordance with the present disclosure.

Axis 199 is illustrated as a longitudinal axis (e.g., front-rear axis) of vehicle 100. Drive unit 101 is arranged longitudinally corresponding to a rear drive axis of vehicle 100 (e.g., corresponding to rear wheels 103), indicated in FIG. 1 as region 191. Storage system 110 is arranged longitudinally proximal to the rear of drive unit 105, indicated in FIG. 1 as region 192. Bumper 120 is arranged longitudinally at the rear of vehicle 100, indicated in FIG. 1 as region 193. In an illustrative example, storage system 110 may be configured to store equipment (e.g., sporting gear, tools, materials, luggage, etc.), a wheel (e.g., a “spare tire” including a tire and rim), or any other suitable items. Because storage system 110 is arranged at an end (e.g., the rear) of vehicle 100, a user may access storage system 110 from the end of the vehicle (e.g., without need to crawl under vehicle 100 or clear out compartment 102), using access 111. For example, when stowed, storage system 110 is arranged in region 192, and when released, storage system 110 extends at least partially into region 193 to allow the user greater access.

In an illustrative example, storage system 110 includes a winch that is accessible from the end of vehicle 100 via access 111. In some embodiments, access 111 includes a tube or handle that extends from a spool (e.g., that wind a winch cable), and a user may actuate the handle or insert a tool into the handle to turn the spool (e.g., via a gear mechanism, or directly) and advance or retract the winch cable.

FIG. 2 shows several illustrative embodiments of storage systems, in accordance with some embodiments of the present disclosure. Panel 200 illustrates a fully stowed configuration of illustrative storage system 110 of FIG. 1. Each of panels 250, 260, and 270 illustrate examples of trajectories achieved by a tray of a storage system. It will be understood that any of the systems of panels 250, 260, and 270, or aspects thereof, may be combined in any suitable manner to achieve a stowed position and an accessible position. The stowed configuration of panel 200 may correspond to a space in vehicle 100 under compartment 102, outward of drive unit 105, and inward of bumper 202.

As illustrated in panel 250, storage system 251 is a sliding system (e.g., a horizontal translation). As illustrated in panel 250, storage system 251 (e.g., or a tray thereof) has undergone a trajectory to position 255. In position 255, storage system 251 (e.g., a tray thereof) is arranged outward of bumper 252, thus allowing full access by the user. Panel 250 illustrates storage system 251 that is configured to translate primarily horizontally (e.g., within 5 degree, 10 degrees, 20 degrees or 30 degrees of a horizontal line) along an approximately straight trajectory. For example, as illustrated in panel 250, storage system 251 may translate longitudinally (e.g., corresponding to the direction along axis 199 of FIG. 1).

As illustrated in panel 260, storage system 261 is a rotating and sliding system (e.g., exhibiting a rotation and translation). As illustrated in panel 260, storage system 261 (e.g., or a tray thereof) has undergone a trajectory to position 265. In position 265, storage system 261 (e.g., a tray thereof) is arranged outward (e.g., rearward) of bumper 262, and at a downward angle, thus allowing full access by the user. Panel 260 illustrates storage system 261 that is configured to rotate to an angle below horizontal (e.g., that is less than 30 degrees, between 30-degrees, or more than 45 degrees) and translate along an approximately straight trajectory.

As illustrated in panel 270, storage system 271 is a swinging system (e.g., swing down via a four-bar linkage or other suitable mechanism). As illustrated in panel 270, storage system 271 (e.g., or a tray thereof) has undergone a trajectory to position 275. In position 275, storage system 251 (e.g., a tray thereof) is arranged at least partially outward (e.g., rearward) of bumper 272, and below bumper 272, thus allowing full access by the user. Panel 270 illustrates storage system 271 that is configured to swing down along a curved trajectory, slide at an angle along an approximately straight trajectory, or a combination thereof.

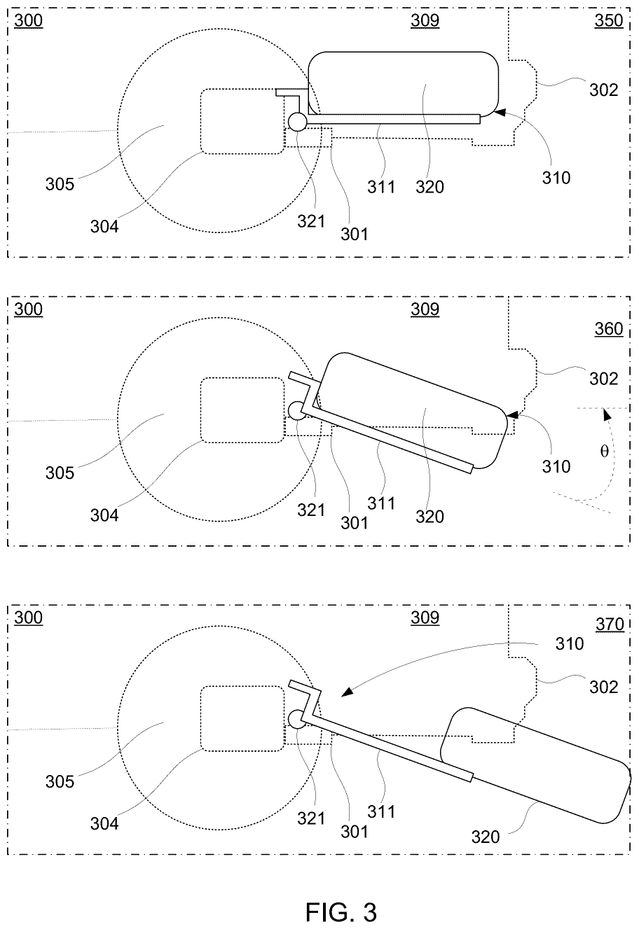

FIG. 3 shows side views of illustrative system 310 for storing items in vehicle 300, corresponding to several configurations, in accordance with some embodiments of the present disclosure. To illustrate, system 310 (e.g., a storage system) is an example of storage system 261 of panel 260 of FIG. 2. As illustrated, vehicle 300 includes subframe 301 (e.g., one or more frame elements), bumper 302, region 309 (e.g., corresponding to a cargo bed or occupant compartment), tray 311 (e.g., illustrated as holding spare tire 320, although any suitable cargo may be stored), hinge 321, drive unit 304 (e.g., arranged at an end of vehicle 300 such as a front end or rear end), and wheel 305. System 310 is arranged outward of drive unit 304 and is coupled to subframe 301 via hinge 321.

Panel 350 shows system 310 in a first configuration (e.g., a fully stowed configuration). In the first configuration, tray 311 is oriented horizontally, and arranged inboard of bumper 302 under region 309. The first configuration may correspond to cargo in tray 311 (e.g., spare tire 320, as illustrated) being stowed and relatively inaccessible to the user.

Panel 360 shows system 310 in a second configuration (e.g., a rotated configuration or partially released configuration). In the second configuration, tray 311 is oriented at an angle θ below horizontal, and still inboard of bumper 302 under region 309. The second configuration may correspond to cargo in tray 311 (e.g., spare tire 320, as illustrated) being partially released but not fully accessible to the user, for example. The second configuration of system 310 is achieved by rotating tray 311 about hinge 321 from the first configuration, under manual power, mechanical power (e.g., gravity, springs, or both), electrical power, or a combination thereof.

Panel 370 shows system 310 in a third configuration (e.g., a fully released configuration). In the third configuration, tray 311 is oriented at angle θ below horizontal, but is at least partially outward of bumper 302. The third configuration may correspond to cargo in tray 311 (e.g., spare tire 320, as illustrated) being released and accessible to the user, for example. The third configuration of system 310 is achieved by translating spare tire 320 from the second configuration, under manual power, mechanical power (e.g., gravity, springs, or both), electrical power, or a combination thereof. For example, in the third configuration, tray 311 is oriented at the angle below horizontal, and an element (not illustrated) on which spare tire 320 is arranged may be positioned outward away from the vehicle relative to a position of the element in the second configuration.

In an illustrative example, in rear motor applications (e.g., where drive unit 304 is at the rear of the vehicle), spare tire 320 may be arranged between drive unit 304, body structure (e.g., subframe 301 and/or other frame elements) and bumper 302 (e.g., a bumper beam thereof), which prevent or otherwise block spare tire 320 from being dropped vertically down (e.g., from the first configuration). System 310 allows spare tire 320 on tray 311 to slide down (e.g., on an angled ramp of tray 311), which controls or otherwise constrains the motion of spare tire 320 when being removed and reinstalled.

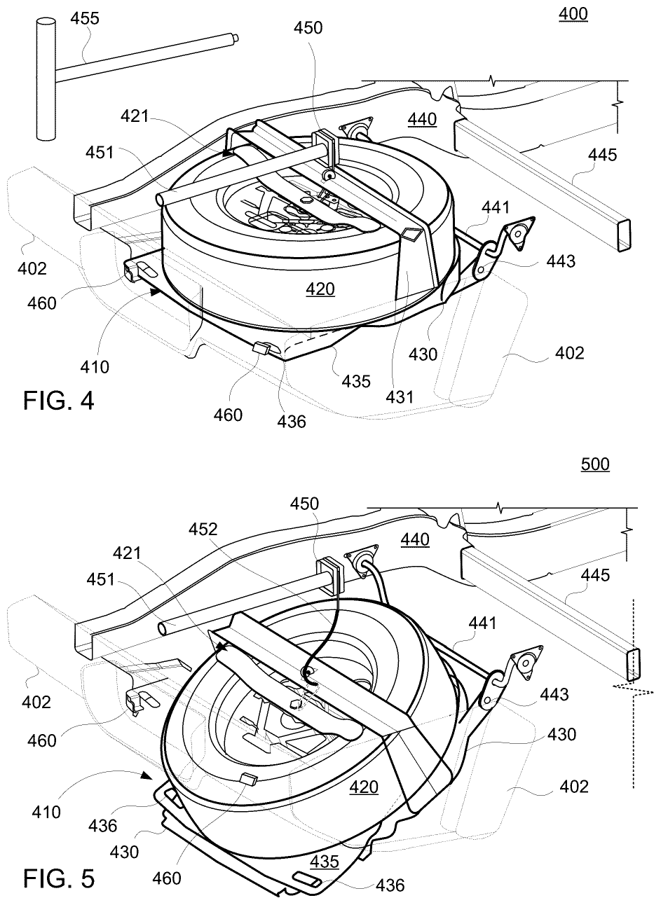

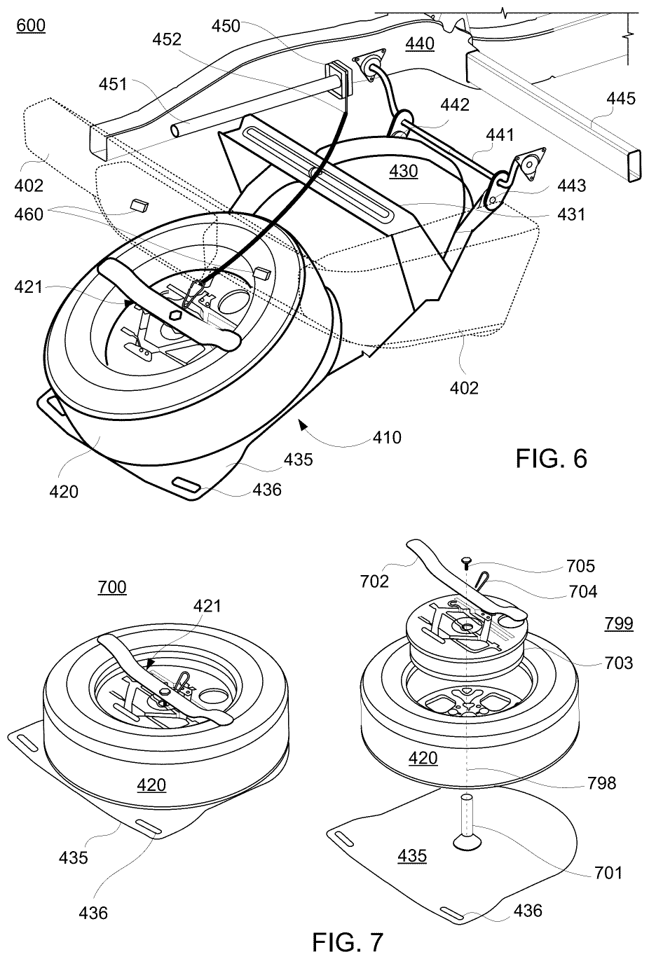

FIG. 4-6 show perspective views of illustrative storage system 410 in several configurations, in accordance with some embodiments of the present disclosure. As illustrated, storage system 410 includes tray 430 with element 431, sheet 435, hinges 442 and 443, hold down 421, element 441, winch 450 with flexible element 452 and winch access 451, and latches 460. Frame elements 440 and 445 are part of a vehicle frame, and bumper 402 is arranged at the rear of the vehicle. As illustrated, storage system 410 is stowing spare tire 420, although it will be understood that storage system 410 may be used to store any suitable items (e.g., gear, equipment, tools, baggage, materials). To illustrate, storage system 410 may be included as part of vehicle 100 of FIG. 1 and may be used to achieve trajectory 221 shown in panel 220 of FIG. 2 (e.g., rotation and translation). Storage system 410 may be included at the rear of the vehicle, arranged behind a rear drive unit and under a cargo bed or occupant compartment (e.g., depending on the type of vehicle). As illustrated, in some embodiments, a user may access storage system 410 from the rear of the vehicle using winch access 451 (e.g., after releasing latches 460), which may correspond to access 111 of FIG. 1 (e.g., configured to be used with tool 455). Configuration 400 is illustrated in FIG. 4, corresponding to a fully stowed configuration (e.g., a first configuration) of storage system 410. Configuration 500 is illustrated in FIG. 5, corresponding to a rotated configuration (e.g., a second configuration) of storage system 410. Configuration 600 is illustrated in FIG. 6, corresponding to a fully advanced configuration (e.g., a third configuration) of storage system 410. In an illustrative example, a tray may include tray 430 and sheet 435 (e.g., an insert that is configured to slide relative to tray 430).

Configuration 400, illustrated in FIG. 4, corresponds to a fully stowed configuration (e.g., an operating configuration for driving), as may be used while the vehicle is driven or parked, or when access to storage is not needed, for example. In configuration 400, sheet 435 is retracted and tray 430 is horizontal (e.g., exactly horizontal or near horizontal). In configuration 400, latches 460 are secured such that tray 430 is locked in place. It will be understood that, in some embodiments, tray 430 may be arranged at 0 degrees from horizontal (e.g., exactly horizontal), or otherwise a relatively small angle in either direction from exactly horizontal (e.g., within 10 degrees, within 5 degrees, within 2 degrees, all of which are considered herein to be horizontal).

Configuration 500, illustrated in FIG. 5, corresponds to a rotated or second configuration (e.g., partially stowed), as may be used when the user is gaining access to storage, for example. In configuration 500, sheet 435 is retracted and tray 430 is rotated below horizontal. For example, in configuration 500, tray 430 may be between 30 and 45 degrees below horizontal, more than 30 degrees below horizontal, less than 60 degrees below horizontal, or any suitable prescribed angle or range of angles (e.g., using one or more bump stops, detents, cables or end of winch travel). In configuration 500, latches 460 are released or otherwise not engaged. To illustrate, the user may cause configuration 500 to be achieved by advancing winch 450 via winch access 451 (e.g., using a specialized tool, manual crank, an automatic or motorized system, or any other suitable mechanism). In some embodiments, a flexible element of winch 450 (e.g., a metal cable, chain or any other suitable flexible element that can be put in tension) slidably interfaces to tray 430 (e.g., element 431 thereof, which may be affixed to or otherwise part of tray 430). For example, element 431 may include an eyelet, bushing, carabiner, loop, any other suitable components, or any combination thereof that allow flexible element 452 (e.g., a cable) of winch 450 to slide. In a further example, sheet 435 or any other suitable element slides longitudinally along tray 430 as flexible element 452 of winch 450 is advanced.

Configuration 600, illustrated in FIG. 6, corresponds to a fully advanced or third configuration (e.g., fully accessible), as may be achieved for stowing or removing items from storage system 410, for example. In configuration 600, sheet 435 is extended and tray 430 is rotated below horizontal. For example, in configuration 500, tray 430 may be between 30 and 45 degrees below horizontal, more than 30 degrees below horizontal, less than 60 degrees below horizontal, or any suitable prescribed angle or range of angles (e.g., using one or more bump stops, detents, cables or end of winch travel). For example, tray 430 may be oriented at the same angle in both configurations 500 and 600. In configuration 600, latches 460 are released or otherwise not engaged. To illustrated, the user may cause configuration 600 to be achieved by advancing winch 450 via winch access 451 further than that achieved for configuration 500 (e.g., using a specialized tool, manual crank, an automatic or motorized system, or any other suitable mechanism). To illustrate, in the third configuration, tray 430 is oriented at the angle below horizontal, and the element (e.g., sheet 435 or other suitable element) is positioned outward from the vehicle relative to a position of the element in the second configuration (e.g., by extending the element outwards).

In an illustrative example, sheet 435 (e.g., a tire tray) is configured to pivot away from a drive unit and compartment floor (e.g., under a cargo bed or occupant compartment) to avoid interference. The trajectory along which tray 430 and sheet 435 travel may include any suitable rotation angle limited by subframe geometry (e.g., of frame elements 440 and 445), drive unit position, ground clearance, bumper position, or a combination thereof. Sheet 435 slides outward, along with stored spare tire 420 (e.g., or any other suitable stored items) to be exposed to the user underneath bumper 402 (e.g., a rear bumper). In some embodiments, sheet 435 is configured to be removable from tray 430, such that sheet 435, holddown 421, and spare tire 420 can be removed from the vehicle after sliding sheet 435 outward. In some embodiments, for example, sheet 435 (e.g., a tire sheet) includes handles 436 (e.g., one or more grab holes) to allow the spare tire assembly (e.g., sheet 435, holddown 421, and spare tire 420) to be pulled out from underneath the vehicle.

In an illustrative example, in some embodiments, winch 450 is affixed to the frame of the vehicle, and flexible element 452 is coupled to sheet 435 such that sheet 435 extends as t flexible element 452 is advanced. In a further example, in some embodiments, flexible element 452 slidably interfaces to tray 430, and tray 430 rotates as flexible element 452 is advanced. To illustrate, tray 430 is arranged at an end of the vehicle and affixed to a frame of the vehicle (e.g., frame elements 440 and 445) by a hinge joint (e.g., hinges 442 and 443). Further, an element (e.g., sheet 435) is arranged on a top surface of tray 430 and is capable of sliding longitudinally along tray 430 and storing equipment under a compartment of the vehicle. In a first configuration (e.g., configuration 400), tray 430 is oriented horizontal and the element (sheet 435) is in a stowed position under a compartment of the vehicle. In a second configuration (e.g., configuration 500), tray 430 is oriented at an angle below horizontal such that the element (e.g., sheet 435) is capable of sliding under bumper 402 of the vehicle.

In an illustrative example, frame elements 440 and 445 may be included as part of a vehicle frame, vehicle subframe, or any other suitable structural member capable of supporting tray 430. Further, frame elements 440 and 445 are merely illustrative, and it will be understood that a tray may be joined to any suitable structural component of the vehicle at a suitable joint. Accordingly, the frame and frame elements may refer to any suitable structure, for which a tray forms a joint with and exhibits relative motion.

FIG. 7 show perspective views of several components of illustrative storage system 410 of FIGS. 4-6, in accordance with some embodiments of the present disclosure. For example, spare tire assembly 700 includes sheet 435, post 701, crossbar 702, kit 703, carabiner 704, fastener 705, and spare tire 420, as illustrated. To illustrate further, holddown 421 includes post 701, crossbar 702, and fastener 705. Panel 799 shows an exploded view of the components of spare tire assembly 700. Post 701 may include an extension that extends away from sheet 435 (e.g., along axis 798) for centering spare tire 420. In some embodiments, post 701 may be omitted or otherwise replaced with a hub, flange (e.g., with a bolt pattern for securing spare tire 420), pocket or recess, studs arranged in a pattern matching the lug pattern of spare tire 420, any other suitable components, or any combination thereof. Kit 703 may include a service kit or other suitable auxiliary system (e.g., a lifting jack, a lug wrench, a tire patch kit, an air compressor, spare fuses, or bulbs) that is configured to be arranged in the center recess of spare tire 420. In some embodiments, flexible element 452 (e.g., a winch cable) is coupled to carabiner 704, and may be disconnected from spare tire assembly 700 (e.g., carabiner 704 may include a spring-loaded gate). For example, flexible element 452 may be disconnected from spare tire assembly 700 by releasing carabiner 704, removing fastener 705 (e.g., a wing nut, thumb screw, other suitable threaded component, or a clamp or clasp for holding crossbar 702 down), or a combination thereof. To illustrate, a user may slide spare tire assembly 700 outward from tray 430, remove spare tire assembly 700 from the vehicle, and then remove spare tire 420 from the rest of spare tire assembly 700 (e.g., by removing fastener 705. Accordingly, the user may then place a flat tire or other intended items for storage on sheet 435, slide the new assembly back against tray 430, and then rotate tray 430 back to the stowed position using winch 450.

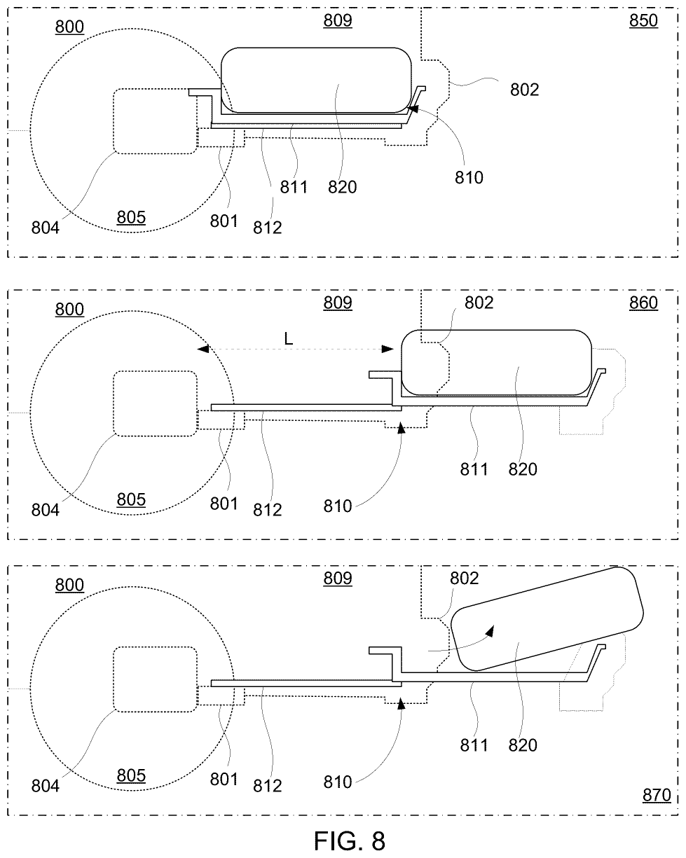

FIG. 8 shows side views of illustrative system 810 for storing items in vehicle 800, corresponding to several configurations, in accordance with some embodiments of the present disclosure. To illustrate, system 810 is an example of storage system 251 of panel 250 of FIG. 2. As illustrated, vehicle 800 includes subframe 801 (e.g., one or more frame elements), bumper 802, region 809 (e.g., corresponding to a cargo bed or occupant compartment), tray 811 (e.g., illustrated as holding spare tire 820, although any suitable cargo may be stored), element 812, drive unit 804, and wheel 805. System 810 is arranged outward of drive unit 804 and is coupled to subframe 801 via element 812. In some embodiments, element 812 includes a surface along which tray 811 slides, a rail mechanism, a slide mechanism, a roller mechanism, or any other suitable system for allowing tray 811 to translate relative to subframe 801. For example, element 812 and tray 811 may be joined by a sliding joint, which may be formed by sliding surfaces, rollers, or any other suitable sliding interface that allows tray 811 to move along element 812 (e.g., linearly or any other suitable trajectory).

Panel 850 shows system 810 in a first or operating configuration (e.g., a fully stowed configuration). In the first configuration, tray 811 is oriented exactly horizontal or near horizontal, and arranged inboard of bumper 802 under region 809. The first configuration may correspond to cargo in tray 811 (e.g., spare tire 820, as illustrated) being stowed and relatively inaccessible to the user. Bumper 802 or a portion thereof is in an operating bumper position against vehicle 800 or otherwise in in a stowed position (e.g., a first bumper position).

Panel 860 shows system 810 in a second configuration (e.g., a translated configuration or fully released configuration). In the second configuration, tray 811 is translated outward a distance L, to extend at least partially outward of bumper 802 (e.g., rearward of bumper 802 if a rear bumper). The second configuration may correspond to cargo in tray 811 (e.g., spare tire 820, as illustrated) being partially released but not fully accessible to the user, for example. The second configuration of system 810 is achieved by translating tray 811 along element 812 from the first configuration, under manual power, mechanical power (e.g., gravity, springs, or both), electrical power, or a combination thereof. Bumper 802 or a portion thereof, as illustrated, may move with tray 811 from the operating bumper position to an extended position (e.g., a second bumper position or extended bumper position), outward of the operating bumper position (e.g., the first bumper position or stowed bumper position).

Panel 870 shows system 810 in the third configuration, with spare tire 820 partially removed, to illustrate how a user may interact with system 810 and cargo stored therein. For example, as illustrated in panel 870, the user may rotate and lift out spare tire 820 from tray 811 and then reverse the motion to replace items into tray 811 for storage.

In an illustrative example, in rear motor applications (e.g., where drive unit 804 is at the rear of the vehicle), spare tire 820 may be arranged between drive unit 804, body structure (e.g., subframe 801 and/or other frame elements), and bumper 802 (e.g., a bumper beam thereof), which prevent or otherwise block spare tire 820 from being dropped vertically down (e.g., from the first configuration). System 810 allows spare tire 820 on tray 811 to slide outward. Bumper 802, or a portion thereof (e.g., a bumper portion) may travel with tray 811 (e.g., a central portion of bumper 802), and another portion of bumper may remain stationary (e.g., side portions). For example, the portion of bumper 802 that moves with tray 811 may interface to a frame of the vehicle in any suitable manner to achieve bumper functionality while allowing the portion of the bumper to move outward when system 810 is moving outward (e.g., in the second configuration of panel 860). In a further example, system 810 may include a portion of bumper 802, which may be affixed to tray 811 or otherwise integrated with tray 811.

In a further illustrative example, tray 811 may be a spare tire tray used as a storage compartment, allowing relatively easy access for loading and unloading a spare tire. In some circumstances, other items such as, for example, wetsuits, swimming clothes, shoes, or any other suitable items can be stored to utilize drying effect and drainage of moisture underneath vehicle 800.

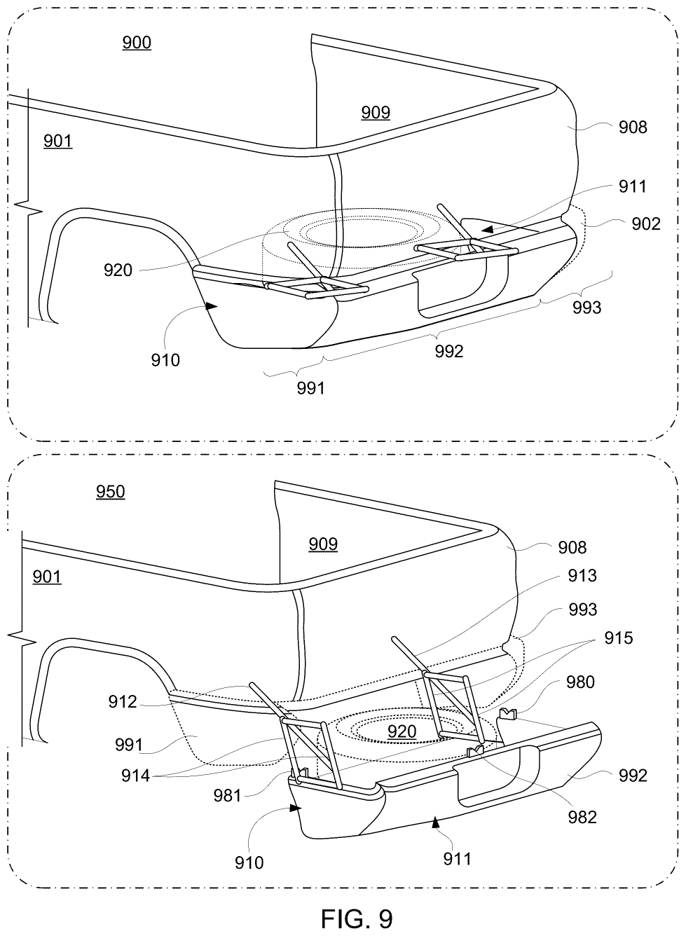

FIG. 9 shows side views of illustrative system 910 for storing items (e.g., spare tire 920) in vehicle 901, corresponding to two configurations illustrated in panels 900 and 950, in accordance with some embodiments of the present disclosure. As illustrated, vehicle 901 includes compartment 909 (e.g., a cargo bed or truck bed, as illustrated), tailgate 908, bumper 902, and system 910. Bumper 902 includes sections 991, 992, and 993. To illustrate, system 910 is an example of storage system 271 of panel 270 of FIG. 2. System 910 includes linkages 914 and 915, elements 912 and 913, tray 911, and section 992 of bumper 902. Linkages 914 and 915 form respective four-bar linkages coupling vehicle 901 (e.g., a frame thereof) and tray 911. Elements 912 and 913 may each include, for example, a strut, an actuator, a damper, a cable, any other suitable component, or any combination thereof that may affect a force on tray 911 or displacement of tray 911. Any or all of latches 980, 981, and 982 may be optionally included and configured to secure or release tray 911 such that tray 911 can achieve a trajectory away from a stowed position.

Panel 900 shows system 910 in a first configuration (e.g., a fully stowed configuration). In the first configuration, tray 911 is arranged inboard of a stowed position of bumper 902 under compartment 909. The first configuration may correspond to cargo in tray 911 (e.g., spare tire 920, as illustrated) being stowed and relatively inaccessible to the user. In the first configuration, the bumper portion (e.g., section 992) is in a first bumper position (e.g., an operating position). In an illustrative example, tray 911 may form a compartment and the compartment may be sealed from the elements (e.g., using weatherstripping, a tight-fitting interface, or other suitable feature to limit exposure of stored items or cargo in the compartment). Tray 911 may be sealed against dust, debris, water, or other material (e.g., that may impinge on tray 911 from under the vehicle).

Panel 950 shows system 910 in a second configuration (e.g., a swung down configuration or fully released configuration). In the second configuration, tray 911 is arranged outward of, and at least partially below, the original position of bumper 902. Section 992, which is a bumper portion, has moved with the rest of tray 911, relative to sections 991 and 993, which remain in place (e.g., in the original or operating bumper position). The second configuration may correspond to cargo in tray 911 (e.g., spare tire 920, as illustrated) being accessible to the user, for example. The second configuration of system 910 is achieved by swinging tray 911, using elements 912 and 913, from the first configuration, under manual power, mechanical power (e.g., gravity, springs, or both), electrical power, or a combination thereof. In an illustrative example, the user may lift out spare tire 920 from tray 911 in the second configuration, replace a flat tire or other suitable equipment, and then re-stow tray 911 back to the first configuration (e.g., as illustrated in panel 900). To illustrate, one or more four-bar linkages (e.g., including linkages 914 and 915) may couple tray 911 to a frame of vehicle 901, and are configured to cause the tray to achieve the first configuration and the second configuration. Further, in the second configuration, tray 911 is also arranged at least partially below the first bumper position (e.g., of the first configuration).

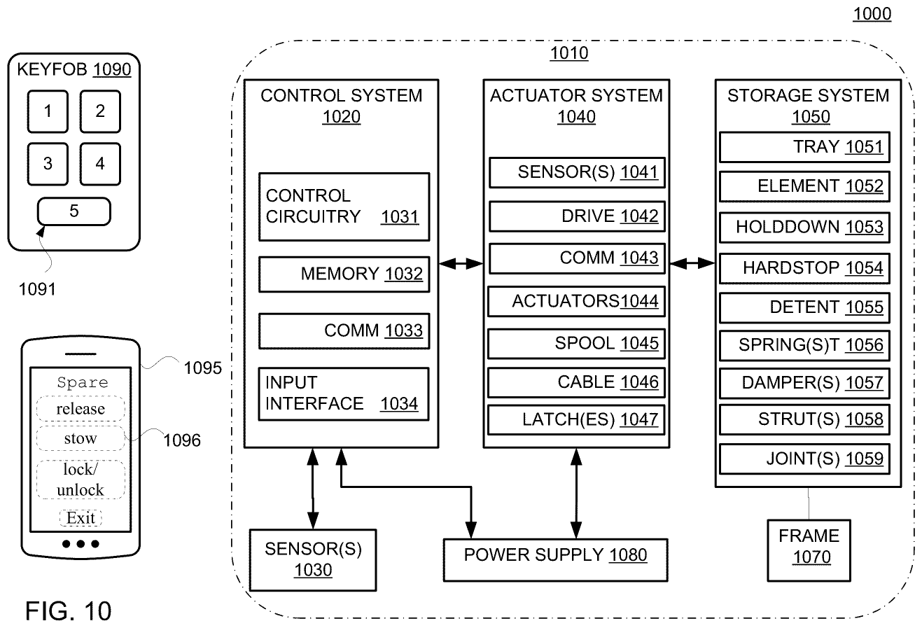

FIG. 10 is a system diagram of illustrative vehicle 1010 having storage system 1050, in accordance with some embodiments of the present disclosure. In an illustrative example, vehicle 1010 is the same as vehicle 100 of FIG. 1, and storage system 1050 may be the same as storage system 110 of FIG. 1 (e.g., a rear storage system). In a further illustrative example, vehicle 1010 and/or storage system 1050 may be the same as, include portions of, or otherwise be similar to any of the vehicles and systems (e.g., storage systems) illustrated in FIGS. 1-9. Although illustrated as separate in FIG. 10, any or all of control system 1020, actuator system 1040, and storage system 1050 may be combined or modified in accordance with the present disclosure. For example, a control system may include the functionality of actuator system 1040, and storage system 1050 may include one or more actuators. Vehicle 1010, as illustrated, includes control system 102, actuator system 1040, storage system 1050, sensors 1030, power supply 1080, and frame 1070. System 1000 includes vehicle 1010 as well as keyfob 1090 and user device 1095, which are configured to communicate with vehicle 1010 (e.g., control system 1020 thereof).

Control system 1020, as illustrated, includes control circuitry 1031, memory 1032, communications interface 1033 (comm 1033), and input interface 1034 (e.g., for receiving input from keyfob 1090 and/or user device 1095). Control circuitry 1031 may include a processor, a communications bus, memory, power management circuitry, a power supply, any suitable components, or any combination thereof. Memory 1032 may include solid state memory, a hard disk, removable media, any other suitable memory hardware, or any combination thereof. In some embodiments, memory 1032 is configured to store computer instructions that, when executed, perform at least some steps of process 1200 described in the context of FIG. 12.

Comm 1033 may include one or more ports, connectors, input/output (I/O) terminals, cables, wires, a printed circuit board, control circuitry, any other suitable components for communicating with other units, devices, or components, or any combination thereof. In some embodiments, control system 230 is configured to control a drivetrain (e.g., control an engine, electric motor, transmission, brake), control or manage a battery system (e.g., power supply 1080), determine status information of the vehicle or components thereof, communicate with other units (e.g., actuator system 1040), perform any other suitable actions, or any combination thereof. In some embodiments, comm 1033, input interface 1034, or both, may be configured to send and receive wireless information between control system 1020 and external devices such as, for example, network devices (e.g., a server, a WiFi access point), user device 1095 (e.g., a smart phone), keyfobs (e.g., keyfob 1090), any other suitable devices, or any combination thereof.

Control system 1020 may include an antenna and other control circuitry (e.g., protocol converters, rate converters, signal converters), or any combination thereof, and may be configured to access the internet, a local area network, a wide area network, a Bluetooth-enable device, an NFC-enabled device, any other suitable device using any suitable protocol, or any combination thereof. In some embodiments, input interface 1034 includes, for example, a screen, a touchscreen, a touch pad, a keypad, one or more hard buttons, one or more soft buttons, a microphone, a speaker, any other suitable components, or any combination thereof. For example, in some embodiments, input interface 1034 includes all or part of a dashboard, including displays, dials and gauges (e.g., actual or displayed), soft buttons, indicators, lighting, and other suitable features.

Actuator system 1040, as illustrated, includes one or more sensors 1041, drive 1042, communications interface (comm) 1043, one or more actuators 1044, spool 1045, cable 1046, and latches 1047. Sensor(s) 1041 may include position sensors, voltage sensors, current sensors, temperature sensors, impedance sensors, any other suitable sensors, or any combination thereof. In some embodiments, sensor(s) 1041 are configured to sense electrical parameters corresponding to operation of a winch (e.g., having a motor of actuators 1044) such as, for example, current flow, voltage or voltage drop, temperature or change thereof, resistance or change thereof, capacitance or change thereof, inductance or change thereof, any other suitable property, or any combination thereof. Sensor(s) 1041 may include loop-type current transformer sensors, shunts or precision resistors, thermocouples, thermopiles, resistance temperature detectors (RTDs), thermistors, any other suitable components or hardware, or any combination thereof. For example, sensor(s) 1041 may include a current sensor configured to sense current in an alternating current (AC) line (e.g., a line or neutral) or a line of a DC bus associated with a motor of actuators 1044. Drive 1042 may include a motor drive, having power electronics and a controller, for providing electrical power to actuators 1044 and/or latches 1047 (e.g., from power supply 1080). For example, actuator system 1040 may be configured to control current flow to a winch motor or other suitable actuator of actuators 1044. Comm 243 may include one or more ports, connectors, cables, wires, input/output (I/O) terminals, a printed circuit board, control circuitry, any other suitable components for communicating with other units, devices, or components, or any combination thereof. For example, comm 243 may be configured to interface to comm 1033 of control system 1020, any other suitable device or components, or any combination thereof. Latches 1047 may include, for example, latches 980 and 981 of FIG. 9.

Storage system 1050, as illustrated, includes tray 1051, element 1052 (e.g., an insert for holding stored items), holddown 1053 (e.g., for securing items to tray 1051), hardstop 1054 (e.g., for limiting a position of tray 1051), detent 1055 (e.g., for discretizing stable positions of tray 1051), one or more springs 1056 (e.g., for applying a force on tray 1051 based on displacement), one or more dampers 1057 (e.g., for counteracting momentum of tray 1051), one or more struts 1058 (e.g., for providing structural support to tray 1051 or joints 1059), one or more joints 1059 (e.g., for allowing relative motion of tray 1051 and other components such as frame 1070), any other suitable components, or any suitable combination thereof (e.g., a subset of components illustrated in FIG. 10). In some embodiments, element 1052 may be an insert that interfaces with tray 1051 (e.g., and may, but need not, be capable of relative motion). In some embodiments, tray 1051 and element 1052 are a single component (e.g., need not be separate components or features). In an illustrative example, a tray as referred to herein may include tray 1051 and optionally element 1052 (e.g., a sheet or other suitable insert that interfaces to tray 1051). Any of the illustrative storage systems of the present disclosure may include one or more of hardstop 1054, detent 1055, springs 1056, dampers 1057, struts 1058, and joints 1059. Element 1052 may include a sheet (e.g., as illustrated in FIGS. 4-7), a carriage, an enclosure, any other suitable component capable of storing items and interfacing to tray 1051.

Power supply 1080 may include, for example, a vehicle battery pack that may include a plurality of battery cells. For example, power supply 1080 may include battery cells, busbars, current collectors, enclosures, DC bus cables or otherwise conductors, contactors, switches, sensors and instrumentation, any other suitable components, or any combination thereof.

Keyfob 1090, as illustrated, includes five buttons 291 (e.g., labeled as 1-5 for illustrative purposes). Each of buttons 1091 may correspond to a particular function associated with the vehicle. When any of buttons 1091 is pressed, control circuitry of keyfob 1090 may receive a signal that corresponds to the button press (e.g., from an electrical switch or sensor coupled to the button) and generate a message or otherwise a signal for transmitting to comm 1033 or comm 1043. To illustrate, one or more of buttons 1091 may correspond to a “stow” command, a “release” command, or both for controlling storage system 1050 (e.g., for achieving a configuration of storage system 1050). User device 1095 may include a smart phone, laptop, tablet, computer, any other suitable mobile or user device, or any combination thereof. As illustrated, user device 1095 includes three soft buttons 1096, each corresponding to a particular function associated with the storage system. When any of soft buttons 1096 is selected, control circuitry of user device 1095 may receive a signal that corresponds to the button press (e.g., from an electrical switch or sensor coupled to the button), and in response generate a message or otherwise signal for transmitting to a communications interface of vehicle 1010 (e.g., comm 1033 or comm 1043). In an illustrative example, the user may select an application implemented on user device 1095 to control storage system 1050. As illustrated, soft buttons 1096 include a “release” button (e.g., to make items in storage system 1050 accessible), a “stow” button (e.g., to secure storage system 1050), and a “lock/unlock” button (e.g., to secure one or more latches or locks of storage system 1050) to provide respective commands to control system 1020.

In an illustrative example, storage system 1050 may correspond to system 310 of FIG. 3. In some embodiments, actuators 1044 may include a motor coupled to hinge 321 of joints 1059. In some embodiments, storage system 320 of FIG. 3 optionally includes hardstop 1054 to limit a rotational position of tray 311 (e.g., corresponding to tray 1051 and/or element 1052). In some embodiments, system 310 of FIG. 3 optionally includes detent 1055 to cause discrete equilibrium positions of tray 311. In some embodiments, system 310 of FIG. 3 optionally includes springs 1056 to apply a force to tray 311, to counteract a gravitational force, impart a restoring force, or otherwise affect motion of tray 311. In some embodiments, system 310 of FIG. 3 optionally includes one or more dampers 1057 to limit rotational velocity of tray 311, or otherwise limit or affect movement of tray 311. In some embodiments, system 310 of FIG. 3 optionally includes one or more struts 1058 to act as structural elements for hinge 321 to mount to in order to allow relative displacement of tray 311. In some embodiments, system 310 of FIG. 3 optionally includes element 1052 configured to store items, where element 1052 may be configured to slide against or be removable from tray 311. In some embodiments, system 310 of FIG. 3 optionally includes holddown 1053 to secure stored items against tray 1051 and/or element 1052.

In an illustrative example, storage system 1050 may correspond to system 810 of FIG. 8. In some embodiments, actuators 1044 may include a linear actuator (e.g., a motor with a screw gear, a rack and pinion mechanism, or other suitable actuator and mechanism) coupled to element 812 of joints 1059. In some embodiments, system 810 of FIG. 8 optionally includes hardstop 1054 to limit a translational position of tray 811 (e.g., corresponding to tray 1051 and/or element 1052). In some embodiments, system 810 of FIG. 8 optionally includes detent 1055 to cause discrete equilibrium positions of tray 811. In some embodiments, system 810 of FIG. 8 optionally includes springs 1056 to apply a force to tray 811, to counteract a gravitational force, impart a restoring force, or otherwise affect motion of tray 811. In some embodiments, system 810 of FIG. 8 optionally includes one or more dampers 1057 to limit linear velocity of tray 811, or otherwise limit or affect movement of tray 811. In some embodiments, system 810 of FIG. 8 optionally includes one or more struts 1058, which may act as element 812 to mount to in order to allow relative displacement of tray 811. In some embodiments, system 810 of FIG. 8 optionally includes element 1052 to store items, where element 1052 may be configured to slide against or be removable from tray 811. In some embodiments, system 810 of FIG. 8 optionally includes holddown 1053 to secure stored items against tray 1051 and/or element 1052. In some embodiments, element 812 of FIG. 8 may be rigidly affixed to, or otherwise be a part of, frame 1070.

In an illustrative example, storage system 1050 may correspond to system 910 of FIG. 8. In some embodiments, actuators 1044 may include a linear actuator (e.g., a motor with a screw gear, a rack and pinion mechanism, or other suitable actuator and mechanism) corresponding to either or both of elements 912 and 913 (e.g., which form a four-bar of joints 1059). In some embodiments, system 910 of FIG. 9 optionally includes hardstop 1054 to limit a swung down position of tray 911 (e.g., corresponding to tray 1051 and/or element 1052). In some embodiments, system 910 of FIG. 9 optionally includes detent 1055 to cause discrete equilibrium positions of tray 911 during the swinging trajectory. In some embodiments, system 910 of FIG. 9 optionally includes springs 1056 to apply a force to tray 911, to counteract a gravitational force, impart a restoring force, or otherwise affect motion of tray 911. In some embodiments, system 910 of FIG. 9 optionally includes one or more dampers 1057 (e.g., corresponding to either or both of elements 912 and 913) to limit velocity of tray 911, or otherwise limit or affect movement of tray 911. In some embodiments, system 910 of FIG. 9 optionally includes element 1052 to store items, where element 1052 may be configured to slide against or be removable from tray 911. In some embodiments, system 910 of FIG. 9 optionally includes holddown 1053 to secure stored items against tray 911.

In an illustrative example, in some embodiments, tray 1051 is configured to seal against a mating surface of vehicle 1010. For example, the mating surface may include a dock, plate, sheet, portion of the undercarriage, any other suitable portion of vehicle 1010, or any combination thereof. In some embodiments, the interface between tray 1051 and the mating surface of vehicle 1010 may include weatherstripping or other suitable compliant material for preventing or otherwise limiting water or other environmental elements from passing across the interface. In some embodiments, the interface between tray 1051 and the mating surface of vehicle 1010 may include relatively tight tolerances, overlap, or other suitable features for preventing or otherwise limiting liquids from splashing or dripping, dust from collecting or crossing the interface, debris from damaging items stored in tray 1051, or a combination thereof. In some embodiments, for example, tray 1051, element 1052, or both may form a compartment and the compartment may be, but need not be, sealed from the elements. In some embodiments, tray 1051, element 1052, or both may be relatively open to the environment and need not be sealed against the elements. In some embodiments, tray 1051, element 1052, or both, include one or more drainage features such as, for example, holes, channels, ports, valves (e.g., to control a release of liquid), or a combination thereof to allow water or other material to flow out of the compartment. For example, if wet or muddy gear is stored in the compartment, the one or more drainage features may allow for the water, mud, or otherwise liquid to run off and drain beneath vehicle 1010. In a further example, in some embodiments, if the compartment is not sealed, tray 1051, element 1052, or both may include a drainage feature to allow splashed material to be drained. In a further example, in some embodiments, if the compartment is sealed, tray 1051, element 1052, or both may include a drainage feature to allow liquid or mud to be drained from stored items (e.g., that are stored in a muddied or wet state).

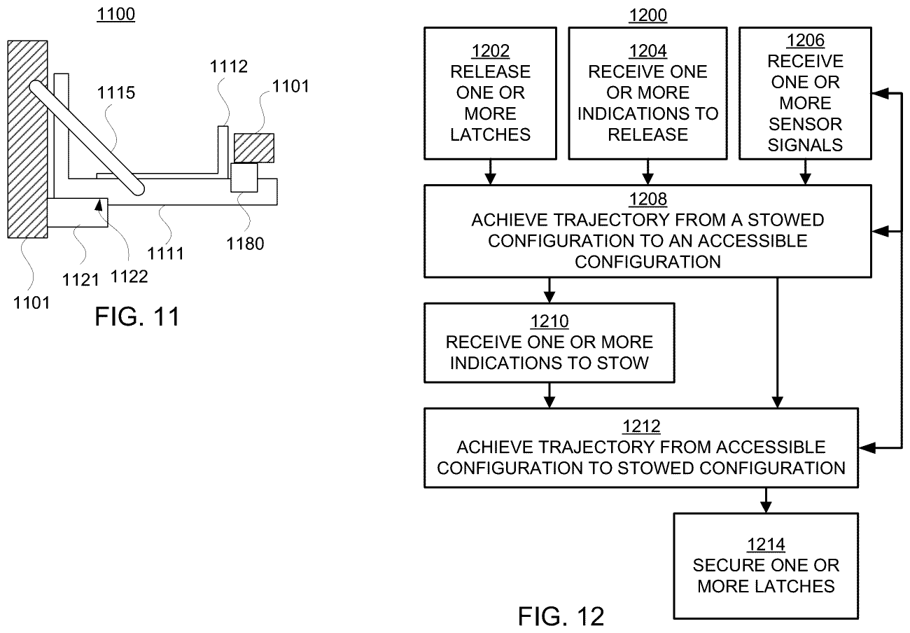

FIG. 11 is a block diagram of illustrative storage system 1100, in accordance with some embodiments of the present disclosure. As illustrated, storage system 1100 includes tray 1111 and insert 1112. Storage system 1100 also includes element 1121, which forms joint 1122 with tray 1111. Joint 1122 may allow rotation, translation, swinging, or a combination thereof, and constrain other trajectories of motion. Storage system 1100 also includes latch 1180 configured to secure and release tray 1111 from frame 1101. Storage system 1100 also includes one or more elements 1115, which may include any or all of hardstop 1054, detent 1055, springs 1056, dampers 1057, and struts 1058 of storage system 1050 of FIG. 10. For example, element 115 may couple tray 1111 to frame 1101 and affect displacement (e.g., a position, change in position, velocity, motion, trajectory, acceleration) of tray 1111. In an illustrative example, storage system 1100 may correspond to any of rear storage system 110 of FIG. 1, storage system 251 of FIG. 2, storage system 261 of FIG. 2, storage system 271 of FIG. 2, system 310 of FIG. 3, storage system 410 of FIGS. 4-6, system 810 of FIG. 8, system 910 of FIG. 9, or storage system 1050 of FIG. 10. Element 1121 and tray 1111 may interface at a slidable interface or joint (e.g., where tray 111 can slide along element 1121), a hinge joint (e.g., wherein tray 1111 can rotate relative to element 1121), a linkage (e.g., a four-bar mechanism allowing a swinging motion of tray 1111 relative to element 1121), any other suitable interface, or any combination thereof.

FIG. 12 is a flowchart of illustrative process 1200 for accessing and stowing a storage system of a vehicle, in accordance with some embodiments of the present disclosure. In some embodiments, one or more steps of process 1200 may be performed by components of vehicle 1010 of FIG. 10 (e.g., control system 1020, actuator system 1040, and storage system 1050 thereof).

Step 1202 includes releasing one or more latches. In some embodiments, step 1202 includes generating a control signal (e.g., using control system 1020, actuator system 1040, or both), and transmitting the control signal to one or more powered latches (e.g., of latches 1047). In some embodiments, step 1202 may include a user manipulating a manual latch to release the storage system.

Step 1204 includes receiving one or more indications to release the storage system. In some embodiments, step 1204 includes receiving the indication from a user device (e.g., user device 1095), a keyfob (e.g., keyfob 1090), input to an input interface (e.g., input interface 1034), any other suitable interface, or any combination thereof. For example, a user may push a hard button, press a soft button on touchscreen, select a selectable icon on a screen, issue a voice command (e.g., as received at input interface 1034), or otherwise provide the indication to the system. In some embodiments, wherein the storage system is manually operated, step 1204 need not be performed.

Step 1206 includes receiving one or more sensor signals at an input interface. In some embodiments, the system may receive one more sensor signals from sensors 1030 and/or sensors 1041. For example, sensors 103, 1041, or both may include position sensors or limit sensors (e.g., position limit sensors providing a binary signal) configured to provide a signal indicative of tray position, tray position, hinge position, linkage position, any other suitable position, or any combination thereof.

Step 1208 includes achieving a trajectory from a stowed configuration to an accessible configuration. The trajectory may include a rotation (e.g., about a hinge joint), a translation, a curved trajectory, any other suitable path from a first configuration to another configuration, or any combination thereof. In some embodiments, step 1208 includes generating a control signal (e.g., using control system 1020, actuator system 1040, or both), and transmitting the control signal to one or more actuators (e.g., of actuators 1044). For example, actuator system 1040 (e.g., drive 1042 thereof) may control a motor of actuators 1044 to cause tray 1051, or element 1052, to undergo displacement along at least some of the trajectory. In a further example, actuators 1044 may include a rotary motor to impart rotational displacement of tray 1051 (e.g., and/or element 1052), as well as a linear actuator to impart linear displacement of tray 1051 (e.g., and/or element 1052). In a further example, actuators 1044 may include a rotary motor to impart rotational displacement of at least one element of a linkage (e.g., a four-bar linkage, as illustrated in FIG. 9) coupled to tray 1051 (e.g., and/or element 1052) to achieve the trajectory. In some embodiments, step 1208 may include a user manipulating a tray and./or insert of the storage system through the trajectory.

Step 1210 includes receiving one or more indications to stow the storage system. In some embodiments, step 1210 includes receiving the indication from a user device (e.g., user device 1095), a keyfob (e.g., keyfob 1090), input to an input interface (e.g., input interface 1034), any other suitable interface, or any combination thereof. For example, a user may push a hard button, press a soft button on touchscreen, select a selectable icon on a screen, issue a voice command (e.g., as received at input interface 1034), or otherwise provide the indication to the system. In some embodiments, wherein the storage system is manually operated, step 1204 need not be performed. In some embodiments, the indications of steps 1204 and 1210 may be received at the same interface or device (e.g., using different buttons or selectable options).

Step 1212 includes achieving a trajectory from the accessible configuration to the stowed configuration. The trajectory may include a rotation (e.g., about a hinge joint), a translation, a curved trajectory, any other suitable path from a first configuration to another configuration, or any combination thereof. In some embodiments, step 1212 includes generating a control signal (e.g., using control system 1020, actuator system 1040, or both), and transmitting the control signal to one or more actuators (e.g., of actuators 1044). For example, actuator system 1040 (e.g., drive 1042 thereof) may control a motor of actuators 1044 to cause tray 1051, or element 1052, to undergo displacement along at least some of the trajectory. In a further example, actuators 1044 may include a rotary motor to impart rotational displacement of tray 1051 (e.g., and/or element 1052), as well as a linear actuator to impart linear displacement of tray 1051 (e.g., and/or element 1052). In a further example, actuators 1044 may include a rotary motor to impart rotational displacement of at least one element of a linkage (e.g., a four-bar linkage, as illustrated in FIG. 9) coupled to tray 1051 (e.g., and/or element 1052) to achieve the trajectory. In some embodiments, step 1212 may include a user manipulating a tray of the storage system through the trajectory. In some embodiments, the trajectories of steps 1208 and 1212 correspond to the same path, although the direction of motion being opposite. For example, if step 1208 includes a first rotation through a given angle, then step 1212 may include a rotation backwards through the given angle. In a further example, if step 1208 includes a first translation through a given displacement, then step 1212 may include a translation backwards through the given displacement. In a further example, in some embodiments, step 1208 may include achieving a first trajectory from a first position to a second position, and step 1212 may reverse the trajectory by returning to the first position from the second position.

Step 1214 includes securing one or more latches. In some embodiments, step 1214 includes generating a control signal (e.g., using control system 1020, actuator system 1040, or both), and transmitting the control signal to one or more powered latches (e.g., of latches 1047). In some embodiments, step 1214 may include a user manipulating a manual latch to release the storage system. The one or more latches of steps 1202 and 1214 may be the same and may be secured or released using any suitable actuation (e.g., powered, or manual actuation).

In an illustrative example, referencing FIG. 10, process 1200 may be implemented for accessing and stowing storage system 1050 of vehicle 1010. At step 1204, control system 1020 receives one or more indications from keyfob 1090, user device 1095, or input to input interface 1034 to release storage system 1050. For example, the indication may include a signal from actuation of a hard button, soft button, selectable icon, voice command, or any other suitable interaction. At step 1202, control system 1020 may generate a control signal and transmit the control signal (e.g., comm 1033 to comm 1043) to actuator system 1040 to release one or more of latches 1047 (e.g., in response to step 1204). In some embodiments, control system 1020, actuator system 1040, for both receive one or more sensors signals (e.g., from sensors 1030 and/or 1041) indicative of a position of tray 1051, element 1052, or joint 1059 to ensure that a trajectory can be achieved or otherwise monitor displacement along a trajectory. At step 1208, tray 1051, element 1052, joints 1059, or a combination thereof achieving a trajectory from a stowed configuration to an accessible configuration (e.g., under electric power, hydraulic power, pneumatic power, manual power, spring-based forces, gravitational forces, or a combination thereof). The user can then access element 1052, for example, and remove or replace items for storage. Once finished, at step 1210, control system 1020 and/or actuator system 1040 may receiving one or more indications to stow storage system 1050 (e.g., tray 1051 or element 1052 thereof) from any suitable input. The trajectory is reversed at step 1212 to re-configure from the accessible configuration to the stowed configuration (e.g., under electric power, hydraulic power, pneumatic power, manual power, spring-based forces, gravitational forces, or a combination thereof). When returned to the stowed state, one or more latches of latches 1047 may be secured (e.g., based on a control signal from actuator system 1040 or control system 1020).

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A system for storage in a vehicle, the system comprising:
a tray affixed to a frame of the vehicle by a hinge joint; and
an element arranged on a top surface of the tray and configured to slide longitudinally along the tray, wherein:
in a first configuration, the tray is oriented horizontal and the element is in a stowed position under a compartment of the vehicle, and
in a second configuration, the tray is oriented at an angle below horizontal such that the element is capable of sliding under a bumper of the vehicle.

2. The system of claim 1, further comprising a winch accessible from an end of the vehicle, wherein:
the winch is affixed to the frame of the vehicle;
a flexible element of the winch is coupled to the tray; and
the tray rotates as the flexible element is advanced or retracted.

3. The system of claim 1, further comprising a winch accessible from an end of the vehicle, wherein:
the winch is affixed to the frame of the vehicle;
a flexible element of the winch is coupled to the element; and
the element slides longitudinally along the tray as the flexible element is advanced.

4. The system of claim 3, wherein:
the flexible element slidably interfaces to the tray; and
the tray rotates as the flexible element is advanced.

5. The system of claim 1, wherein in a third configuration, the tray is oriented at the angle below horizontal, and wherein the element is positioned outward away from the vehicle relative to a position of the element in the second configuration.

6. The system of claim 5, wherein in the third configuration, the element is positioned at least partially rearward of the bumper.

7. The system of claim 1, wherein:
the bumper is a rear bumper; and
in the stowed position, the tray is arranged longitudinally forward of the rear bumper.

8. The system of claim 1, wherein:
the compartment comprises a cargo bed; and
the tray is arranged beneath the cargo bed.

9. The system of claim 1, wherein:
the vehicle comprises a rear drive unit for driving rear wheels of the vehicle; and
the tray is arranged rearward of the rear drive unit.

10. The system of claim 1, wherein:
the frame of the vehicle comprises:
at least one frame element; and
a strut affixed to the at least one frame element; and
the hinge joint affixes the tray to the strut.

11. The system of claim 1, wherein the element comprises a sheet and a holddown, and wherein the sheet is configured to store a spare tire of the vehicle.

12. The system of claim 1, further comprising a latch for securing and releasing the tray from the frame of the vehicle.

13. A system for storage in a vehicle, the system comprising:
a tray arranged outward of a drive unit of the vehicle capable of storage under a compartment of the vehicle, wherein:
in a first configuration, the tray is stowed under the compartment and a bumper portion of the vehicle is in a first bumper position, and
in a second configuration, the tray is arranged at least partially outward of the first bumper position.

14. The system of claim 13, wherein in the second configuration, the bumper portion is in an extended bumper position outward of the first bumper position.

15. The system of claim 14, wherein, in the second configuration, the tray is in a second bumper position lower than the first bumper position.

16. The system of claim 13, further comprising a four-bar linkage coupling the tray to a frame of the vehicle, wherein in the second configuration, the tray is also arranged at least partially below the first bumper position, and wherein the four-bar linkage is configured to cause the tray to achieve the first configuration and the second configuration.

17. The system of claim 13, further comprising a slide interface between the tray and a frame of the vehicle, wherein the tray is configured to slide to achieve the first configuration and the second configuration.

18. A vehicle comprising:
a drive unit arranged at a drive axis of the vehicle;
a frame;
a tray affixed to the frame of the vehicle by a hinge joint; and
an element arranged on a top surface of the tray and capable of sliding longitudinally along the tray, wherein:
in a first configuration, the tray is oriented horizontal and the element is in a stowed position under a compartment of the vehicle, and
in a second configuration, the tray is oriented at an angle below horizontal such that the element is capable of sliding outward under a bumper of the vehicle.

19. The vehicle of claim 18, further comprising a winch accessible from an end of the vehicle, wherein:
the winch is affixed to the frame;
a flexible element of the winch is coupled to the element; and
the tray rotates as the flexible element is advanced.

20. The vehicle of claim 18, wherein:
in the first configuration, the tray is arranged inward of the bumper; and
in a third configuration, the tray is oriented at the angle below horizontal and the element is in an extended position at least partially outward of the bumper.
